(19) United States
(12) Patent Application Publication
(10) Pub. No.: US 2011/0159207 A1
(43) Pub. Date: Jun. 30, 2011

(54) METHOD FOR PRODUCING BUILD-UP SUBSTRATE

(75) Inventors: Tomoyuki KAMAKURA, Matsumoto (JP); Akihiko TSUNOYA, Suwa (JP)

(73) Assignee: SEIKO EPSON CORPORATION, Tokyo (JP)

(21) Appl. No.: 12/973,201

(22) Filed: Dec. 20, 2010

(30) Foreign Application Priority Data
Dec. 24, 2009 (JP) 2009-292729

(51) Int. Cl. B05D 5/12; B05D 1/26; B05D 3/02; B05D 1/38; B05D 3/06

(52) U.S. Cl. 427/555; 427/97.3

(57) ABSTRACT

A method for producing a build-up substrate containing two layers of wiring patterns that are separated from each other with an insulating film intervening therebetween and are electrically connected to each other at a contact part penetrating through the insulating film, includes: ejecting a liquid repelling agent having repellency to an ink for forming the insulating film from a liquid droplet ejecting head onto one of the wiring patterns, thereby forming a liquid repelling part; then ejecting the ink for forming the insulating film from a liquid droplet ejecting head onto portions on the wiring pattern except for the liquid repelling part provided, thereby forming the insulating film; then removing the liquid repelling part; and then forming the contact part and the other of the wiring patterns by electroless plating.

### BACKGROUND

1. Technical Field

The present invention relates to a method for producing a build-up substrate.

2. Related Art

According to the miniaturization of electronic equipments in recent years, circuit boards used in the electronic equipments are developed to have a multilayer structure, fine wiring and electronic devices mounted highly densely. In response to the demands, application of a build-up multilayer wiring structure is being actively pursued. In an ordinary build-up multilayer wiring structure, an insulating layer is provided between plural wiring layers, and a via hole is formed in the insulating layer for conduction between the wiring layers. The via hole is formed in the insulating layer by such a forming method as formation of the hole by photolithography using a photosensitive resin or formation of the hole by laser irradiation. A conductive wiring layer is then formed with copper or the like on the insulating layer by electroless metal plating or electroplating, and is formed into a wiring pattern of a conductor, such as copper, by photolithography, etching and the like. Furthermore, a process of formation of an insulating layer and formation of a wiring pattern thereon is repeated depending on necessity to form a multilayer structure of a circuit board. However, the use of photolithography for formation of the insulating layers and the wiring patterns brings about problems including complicated production process and high production cost.

Under the circumstances, a method for producing an electronic device capable of forming a multilayer wiring by forming an insulating film (insulating layer) and a wiring pattern without the use of photolithography (as described, for example, in Japanese Patent No. 3925283). In the production method, an electroconductive ink containing electroconductive particles is ejected from an ink-jet head onto a substrate, and then the electroconductive ink is dried to form plural ink droplets on the substrate. An electroconductive ink is ejected from an ink-jet head, thereby being disposed among the plural ink droplets, and the electroconductive ink is dried and combined with the ink droplets to form a wiring pattern. Subsequently, an electroconductive ink is ejected from an ink-jet head onto the wiring pattern, and the electroconductive ink thus ejected is dried to form conductor posts. An electroconductive ink is further ejected from an ink-jet head onto the conductor posts, and the electroconductive ink thus ejected is dried to increase the height of the conductor posts. After the conductor posts reach the necessary height, the wiring pattern and the conductor posts are integrated by heating. An ink for forming an insulating film is then ejected from an ink-jet head onto the wiring pattern, and the ink is dried to form an insulating film on the wiring pattern, and simultaneously to make a part of the conductor posts protrude from the insulating film. A wiring pattern of the second layer is formed on the insulating film, and the conductor posts and the second layer wiring pattern are connected to each other in the state where the wiring pattern and the second layer wiring pattern are insulated with the insulating film.

In the case where a wiring pattern and conductor posts are formed by the method described in Japanese Patent No. 3925283, plural ink droplets are repeatedly formed by ejecting and drying an electroconductive ink onto a substrate or a wiring pattern, thereby forming a wiring pattern having a necessary thickness or conductor posts having a necessary height. For example, a conductor post for electrically connecting the wiring pattern and the second layer wiring pattern is formed in such a manner that plural liquid droplets 52 formed by ejecting an electroconductive ink onto the wiring pattern 51 are accumulated on each other while the droplets are dried in each time after ejection, as shown in FIGS. 6A and 6B. However, the electroconductive ink contains metal fine particles encapsulated with a dispersant, which are dispersed in a solvent, and thus a liquid droplet thus ejected from an ink-jet head and reaches the substrate or the like is spread through wetting to not a small extent. For forming a conductor post having the prescribed height, the number of times of ejection and drying of the liquid droplets per unit area is larger in the area of the conductor post than in the area of the wiring pattern. Even though the liquid droplets thus ejected are in a constant state, the ink droplets are not formed under the constant condition due to variation in wetting and spreading conditions of the liquid droplets before drying, and the diameters and the positions where the ink droplets are formed are liable to be fluctuated.

For example, in the case where seven ink droplets 52 are accumulated, the ink droplets 52 shown by the numeral 3 formed with a liquid droplets ejected third is disposed on the ink droplets 52 shown by the numerals 1 and 2, as shown in FIG. 6A. In the state shown in FIG. 6B, however, the ink droplet 52 of the numeral 3 is spread to and wets the side portions of the ink droplets 52 of the numerals 1 and 2, thereby increasing the diameter of the conductor post and deviating the position thereof from the target position. One ink droplet 52 may not be necessarily formed by drying one liquid droplet, and as shown in FIG. 6C, there are cases where plural small liquid droplets 52a, which are sequentially ejected, are aggregated and dried to form one ink droplet.

### SUMMARY

An advantage of some aspects of the invention is to provide a method for producing a build-up substrate, capable of forming a build-up structure in such a state that contact parts (conductor posts), which electrically connect wiring patterns disposed as being insulated from each other, are prevented from being fluctuated in cross sectional area and position thereof.

According to an aspect of the invention, there is provided a method for producing a build-up substrate containing two layers of wiring patterns that are separated from each other with an insulating film intervening therebetween and are electrically connected to each other at a contact part penetrating through the insulating film. The method includes: ejecting a liquid repelling agent having repellency to an ink for forming the insulating film from a liquid droplet ejecting head onto one of the wiring patterns, thereby forming a liquid repelling part; then ejecting the ink for forming the insulating film from a liquid droplet ejecting head onto portions on the wiring pattern except for the liquid repelling part provided, thereby forming the insulating film; then removing the liquid repelling part; and then forming the contact part and the other of the wiring patterns by electroless plating.

According to the aspect, the insulating film (interlayer insulating film) can be formed without photolithography, etching and perforation, and thus a build-up substrate (multilayer wiring board) can be produced in a simplified process. Furthermore, the insulating film is formed by the liquid droplet ejecting method on the wiring pattern having the liquid repelling part provided thereon, and thus the insulating film can be formed by excluding accurately the position on the wiring pattern where the contact part is to be formed. Accordingly, the build-up structure can be formed in such a state that contact parts (conductor posts), which electrically connect two layers of wiring patterns disposed as being insulated from each other, are prevented from being fluctuated in cross sectional area and position thereof.

It is preferred in the method for producing a build-up substrate according to the aspect of the invention that the one of the wiring patterns is formed by a method containing: surface-treating a substrate on at least a portion where the wiring pattern is to be formed; forming a catalyst pattern by ejecting a catalyst liquid from a liquid droplet ejecting head onto the substrate, on the portion where the wiring pattern is to be formed; baking the catalyst pattern; and performing electroless plating on the baked catalyst pattern to form the one of the wiring patterns, and the contact part and the other of the wiring patterns are formed by a method containing: forming a liquid repelling part by ejecting a liquid repelling agent having repellency to an ink for forming the insulating film from a liquid droplet ejecting head onto the one of the wiring patterns formed by the electroless plating, on a portion where the contact part is to be formed; forming an insulating film by ejecting an ink for forming the insulating film from a liquid droplet ejecting head onto the substrate except for the liquid repelling part provided, and then baking the ink; surface-treating the insulating film by performing simultaneously a surface treatment of the insulating film and removal of the liquid repelling part, under a condition where the liquid repelling part is removed; forming a catalyst pattern by ejecting a catalyst liquid from a liquid droplet ejecting head onto the insulating film surface-treated on the portion where the wiring pattern is to be formed; baking the catalyst pattern; and performing electroless plating on the baked catalyst pattern to form the other of the wiring patterns and the contact part.

According to this preferred embodiment, the catalyst pattern, the liquid repelling part and the insulating film are formed by a liquid droplet ejecting method where liquid droplets are ejected from a liquid droplet ejecting head. Therefore, in the case, for example, where an apparatus having plural liquid droplet ejecting heads is used as a liquid droplet ejecting apparatus, the catalyst pattern, the liquid repelling part and the insulating film can be formed with one liquid droplet ejecting apparatus only by replacing the electronic file controlling the coating pattern (bitmap), thereby shortening the production period and reducing the production cost.

It is preferred in the method for producing a build-up substrate according to the aspect of the invention that the catalyst pattern is formed with a coupling agent having palladium supported thereon, and the catalyst pattern is baked in a non-oxidizing atmosphere. According to this preferred embodiment, palladium (Pd) can be prevented from becoming partly palladium oxide (PdO), which is different from the case where the catalyst pattern formed with the coupling agent having palladium supported thereon is baked for enhancing the adhesion to the surface of the substrate by heating in the air. A metal ion (such as copper ion) as a wiring material in a plating bath is hardly deposited on palladium oxide, and therefore when palladium becomes partly palladium oxide, the film density of the wiring material formed on the catalyst pattern is decreased, which impairs the adhesion between the wiring pattern and the surface where the wiring pattern is formed. When the catalyst pattern is baked in a non-oxidizing atmosphere, on the other hand, palladium is prevented from becoming partly palladium oxide, thereby enhancing the adhesion between the wiring pattern and the surface where the wiring pattern is formed.

It is preferred in the method for producing a build-up substrate according to the aspect of the invention that the insulating film is surface-treated by irradiating with an ultraviolet ray by excimer laser. According to this preferred embodiment, formation of the surface of the insulating film with good affinity with the catalyst pattern and the elimination (removal) of the liquid repelling part can be performed easily by one operation.

It is preferred in the method for producing a build-up substrate according to the aspect of the invention that the electroless plating is neutral electroless copper plating. According to this preferred embodiment, a less environmental load is imposed as compared to the case where the electroless copper plating bath is strongly alkaline with formaldehyde as a reducing agent, and furthermore, the content of an alkali metal ion, which impairs reliability of semiconductors, is small, thereby facilitating the application of the method to a semiconductor device. Moreover, a plating bath with strong alkalinity decreases the adhesion between the coupling agent and the surface of the substrate or the surface of the insulating film, but the decrease in adhesion can be avoided by the use of a neutral plating bath.

It is preferred in the method for producing a build-up substrate according to the aspect of the invention that the contact part is formed by depositing directly on a surface of the wiring pattern without the catalyst pattern intervening therebetween. According to this preferred embodiment, the resistance at the junction between the wiring pattern and the contact part can be decreased as compared to the case where the contact part is formed by combining ink droplets formed by drying an electroconductive ink.

### BRIEF DESCRIPTION OF THE DRAWINGS

The invention will be described with reference to the accompanying drawings, wherein like numbers reference like elements.

FIG. 1 is a flow chart showing an example of the method for producing a build-up substrate.

FIGS. 2A to 2D are schematic illustrations showing an example of the process for forming a first layer wiring pattern, and FIGS. 2E to 2J are schematic illustrations showing an example of the process for forming a second layer wiring pattern and a contact part connecting the first and second layer wiring patterns.

FIGS. 3A to 3D show an embodiment of the invention, in which FIG. 3A is a schematic plane view showing an example of a part where a catalyst pattern is to be formed upon forming a catalyst pattern, FIG. 3B is a schematic plane view showing an example of a state where a liquid repelling part is formed, FIG. 3C is a schematic illustration showing an example of a part where the liquid repelling part is removed by surface-treating the insulating film, and FIG. 3D is a schematic illustration showing an example of a part where an ink of a catalyst is coated on the insulating film.

FIGS. 4A and 4B show another embodiment of the invention, in which FIG. 4A is a schematic illustration showing an example of a substrate, and FIG. 4B is a schematic illustration showing an example of a build-up substrate.

FIGS. 5A and 5B show still another embodiment of the invention, in which FIG. 5A is a schematic illustration showing an example of a substrate, and FIG. 5B is a schematic illustration showing an example of a build-up substrate.

FIGS. 6A to 6C show embodiments of the related art, in which FIGS. 6A and 6B are schematic illustrations showing formation of a conductor post in the related art, and FIG. 6C is a schematic illustration showing formation of an ink droplet from plural small liquid droplets in the related art.

### DESCRIPTION OF EXEMPLARY EMBODIMENTS

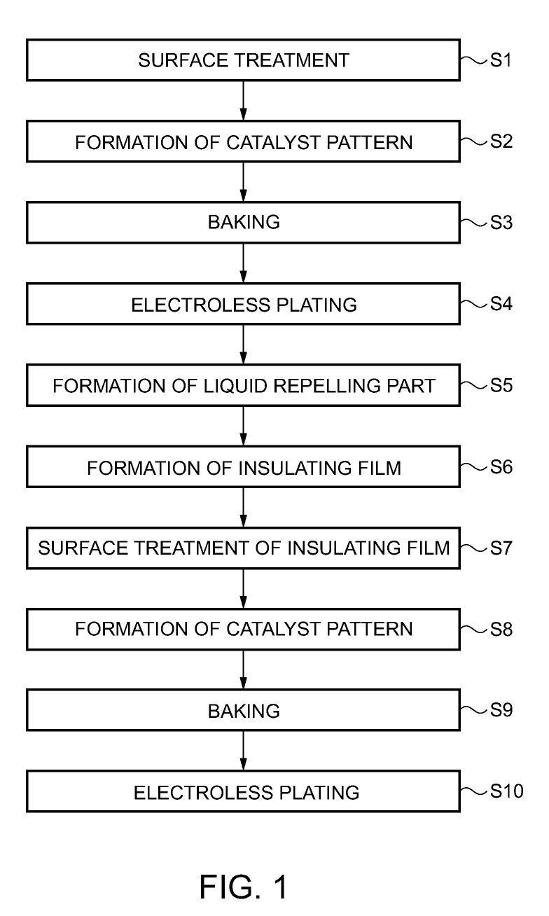

One embodiment of a method for forming a build-up substrate as one implementation of the invention will be described with reference to FIGS. 1, 2A to 2J, and 3A to 3D.

As shown in FIG. 1, the method for forming a build-up substrate according to the embodiment contains, as a process for forming a first layer wiring pattern on a substrate, surface treatment S1, formation of a catalyst pattern S2, baking S3, and electroless copper plating S4. The method for forming a build-up substrate also contains, as a process for forming a second layer wiring pattern and a contact part electrically connecting the first layer wiring pattern and the second layer wiring pattern, formation of a liquid repelling part S5, formation of an insulating film S6, surface treatment of the insulating film S7, formation of a catalyst pattern S8, baking S9, and electroless copper plating S10.

The formation of a catalyst pattern S2 and S8, the formation of a liquid repelling part S5 and the formation of an insulating film S6 are performed by a liquid droplet ejecting method where liquid droplets are ejected from a liquid droplet ejecting head of a liquid droplet ejecting apparatus. The liquid droplet ejecting apparatus used in this embodiment is an ink-jet printer equipped with a liquid droplet ejecting head (ink-jet head) having such a structure that plural kinds of liquids (inks) are fed separately to plural groups of nozzles of one head, and thereby the catalyst patterns, the liquid repelling part and the insulating film are formed with one liquid droplet ejecting apparatus.

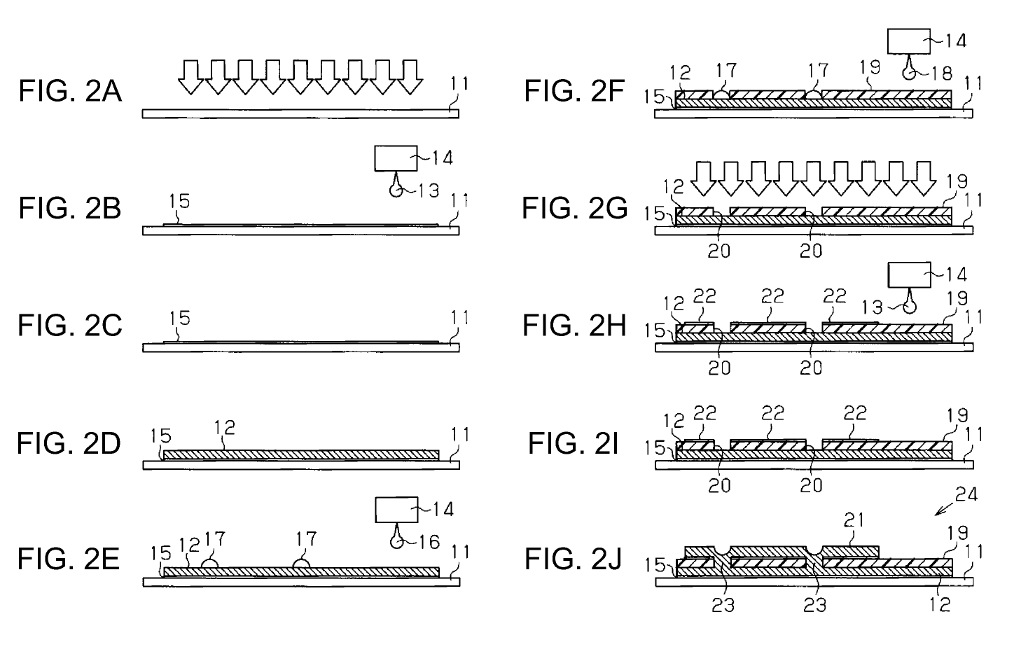

In the surface treatment S1, the portion on the surface of the substrate 11, on which the wiring pattern is to be formed, is subjected to a surface treatment. In this embodiment, the surface treatment performed is a hydrophilization treatment performed for forming hydroxyl groups (OH group) as a hydrophilic group on the surface of the substrate. As the surface treatment, for example, the surface of the substrate 11 is irradiated with an ultraviolet ray (in the presence of oxygen gas) or the surface of the substrate 11 is irradiated with oxygen plasma, as shown in FIG. 2A. As a result, OH groups are formed on the surface of the substrate 11. Examples of the substrate 11 used include a rigid substrate, such as a glass-epoxy resin substrate and a paper-phenol resin substrate, a flexible substrate, such as a polyimide film and a polyester film, and a glass substrate.

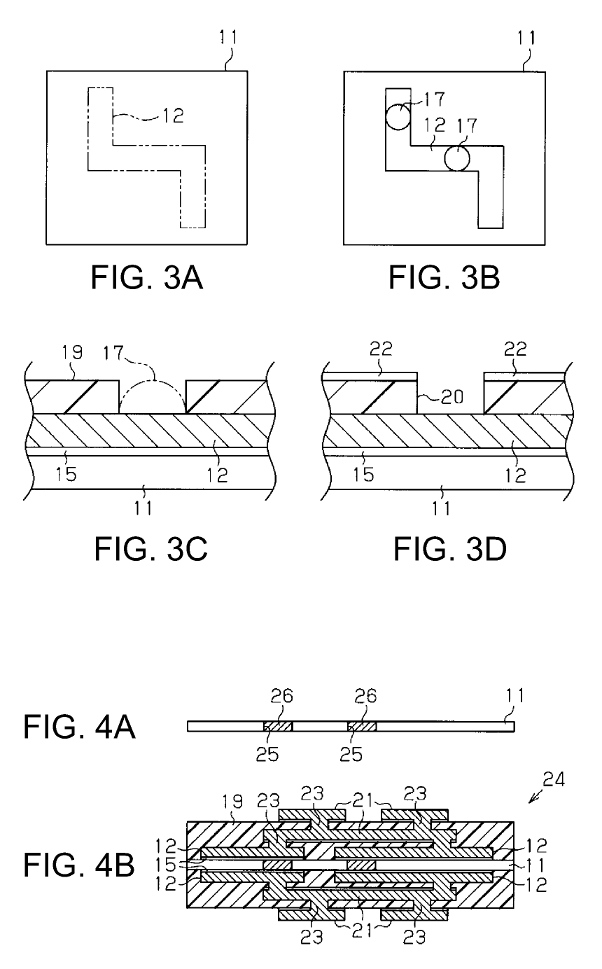

In the formation of a catalyst pattern S2, on the portion on the surface of the substrate 11 having been surface-treated, on which the wiring pattern 12 is to be formed (shown as the portion surrounded by the chained line in FIG. 3A), a catalyst pattern 15 having a shape conforming to the shape of the wiring pattern 12 is drawn by ejecting a catalyst liquid 13 from an ink-jet head 14 as the liquid droplet ejecting head of the liquid droplet ejecting apparatus, as shown in FIG. 2B. The catalyst liquid 13 used contains a solvent having dispersed therein a coupling agent having a plating catalyst supported thereon. Specific examples thereof include a silane coupling agent having an amino group, which is a functional group capable of supporting palladium as a plating catalyst in the molecule thereof, such as an alkyltrialkoxysilane compound (i.e., a so-called amino silane coupling agent). The OH groups formed on the surface of the substrate 11 are connected through hydrogen bond to silanol groups (Si—OH groups), which are formed through hydrolysis of the alkoxy groups of the silane coupling agent.

In the baking S3, the catalyst pattern 15 is baked in a non-oxidizing atmosphere for activation of the catalyst and adhesion thereof to the substrate 11 (as shown in FIG. 2C). The non-oxidizing atmosphere referred herein means an inert gas atmosphere (such as a nitrogen gas atmosphere and an argon gas atmosphere) or a reducing atmosphere (such as an atmosphere containing nitrogen gas or argon gas having hydrogen gas mixed therein).

Dehydration condensation reaction between the OH groups formed on the substrate 11 and the silanol group (Si—OH group) of the silane coupling agent proceeds by baking, the silane coupling agent and the substrate 11 are bonded to each other through covalent bond, which is stronger than hydrogen bond. Dehydration condensation reaction also proceeds between the silanol groups (Si—OH group) of the adjacent pieces of the silane coupling agent, and the adjacent pieces of the silane coupling agent are also bonded through strong covalent bond. Consequently, the catalyst pattern 15 maintains sufficient adhesion to the substrate 11.

For performing smoothly the dehydration condensation reaction, by which the coupling agent is fixed to the substrate 11, the baking temperature may be 100° C. or more, and preferably 120° C. or more. When the organic solvent having the coupling agent dispersed therein has a boiling point that is equal to or lower than the temperatures, the baking temperature may be 100° C. or more, and preferably 120° C. or lower. However, an organic solvent that provides the suitable dispersed state of the coupling agent having the catalyst supported thereon in the catalyst liquid 13 and the suitable wetting and spreading state of the liquid droplets of the catalyst liquid 13 ejected from the ink-jet head 14 reaching the surface of the substrate 11 generally has a boiling point of 150° C. or more, and therefore, the baking temperature is preferably from 150 to 250° C., which is equal to or higher than the organic solvent having the coupling agent dispersed therein.

In the electroless plating S4, copper plating is performed by neutral electroless copper plating to form the wiring pattern 12 on the catalyst pattern 15, as shown in FIG. 2D. A neutral electroless copper plating bath containing Co²⁺ as a reducing agent is used in the neutral electroless copper plating. The use of ordinary electroless copper plating using formaldehyde as a reducing agent lowers the adhesion between the surface of the substrate and the catalyst pattern 15 since the plating bath has strong alkalinity (pH 12 to 13) and facilitates breakage of the covalent bond between the coupling agent and the surface of the substrate. However, the electroless plating herein is performed by neutral electroless plating, and therefore, the covalent bond between the coupling agent and the surface of the substrate is prevented from being broken, thereby preventing deterioration of the adhesion between the surface of the substrate and the catalyst pattern 15.

In the formation of a liquid repelling part S5, a liquid repelling agent 16 having repellency to an ink for forming the insulating film is ejected from the ink-jet head 14 onto the wiring pattern 12 on the portion where the contact part is to be formed (see FIG. 3B), which is formed in the electroless plating S4, thereby forming a liquid repelling part 17, as shown in FIG. 2E.

Examples of the liquid repelling agent 16 used include a fluorine resin dissolved in a solvent, a silane for water repelling treatment dissolved in a solvent, and a silicone oil. Specific examples of the fluorine resin dissolved in a solvent include “EGC1720”, available from Sumitomo 3M, Ltd. (a solution containing a HFE (hydrofluoroether) having dissolved therein 0.1% by weight of a fluorine resin). In this case, a solvent, such as an alcohol solvent, a hydrocarbon solvent, a ketone solvent, an ether solvent or an ester solvent, may be mixed with the HFE solvent, thereby controlling the stable ejection from the ink-jet head 14.

Examples of the silane for water repelling treatment dissolved in a solvent include a solution containing an aromatic solvent, such as a xylene compound saturated with water, having dissolved therein an alkylsilane compound, such as octadecyltrimethoxysilane. Examples thereof also include a solution containing a fluorine compound that is in a liquid state at ordinary temperature and ordinary pressure, such as α,α,α-trifluorotoluene, having dissolved therein a fluoroalkylsilane compound, such as 1H,1H,2H,2H-perfluorodecyltrimethoxysilane.

In the formation of an insulating film S6, an insulating film 19 is formed by ejecting an ink 18 for forming the insulating film 19 from the ink-jet head 14 onto the substrate 11 on the portion except for the liquid repelling part 17, and then the ink 18 is baked to form the insulating film 19, as shown in FIG. 2F. As a result, the insulating film 19 is formed on the portion except for the liquid repelling part 17 on the substrate 11. The ink for forming the insulating film 19 used is a commercially available polyimide varnish (“Pyre ML”, a trade name, available from DuPont), which is controlled in viscosity by diluting with a solvent (N-methyl-2-pyrrolidone). The ink droplets reach the surface of the substrate 11 and the wiring pattern 12, which have affinity to the ink, and are spread thereon, and thus the portion except for the liquid repelling part 17 is completely covered with the ink 18. The surface of the ink 18 is leveled by the self-leveling effect. The ink 18 is coated repeatedly several times with the liquid droplet ejecting apparatus, and is baked for removing the solvent and curing the polyimide.

In the surface treatment of the insulating film S7, the whole of the insulating film 19 and the liquid repelling part 17 are irradiated with an ultraviolet ray by excimer laser (for example, a xenon excimer lamp having an emission center wavelength of 172 nm) (irradiation time: 5 to 10 minutes), as shown in FIG. 2G. As a result, OH groups are formed on the surface of the insulating film 19, thereby completing the surface modification. The liquid repelling part 17 is completely removed (eliminated), and the insulating film 19 thus has a hole 20 at the position where the liquid repelling part 17 is present.

In the formation of a catalyst pattern S8, on the portion on the surface of the insulating film 19 having been surface-treated, on which the second layer wiring pattern 21 is to be formed, a catalyst pattern 22 having a shape conforming to the shape of the wiring pattern 21 is drawn by ejecting the catalyst liquid 13 from the ink-jet head 14, as shown in FIG. 2H. The catalyst liquid 13 is not ejected onto the hole 20, from which the liquid repelling part 17 has been removed.

In the baking S9, the catalyst pattern 22 is baked in a non-oxidizing atmosphere under the similar conditions as in the baking S3 of the catalyst pattern 15, for activation of the catalyst and adhesion thereof to the insulating film 19 (as shown in FIG. 2I).

The electroless plating S10 is then performed, i.e., copper plating is performed by neutral electroless copper plating under the similar conditions as in the formation of the wiring pattern 12, thereby forming the second layer wiring pattern 21 on the catalyst pattern 22 and a contact part 23 connecting the first layer wiring pattern 12 covered with the insulating film 19 and the second layer wiring pattern 21, as shown in FIG. 2J. The contact part 23 is formed by growing through deposition directly on the surface of the first layer wiring pattern 12 without the catalyst pattern 22 intervening therebetween. The contact part 23 is connected, in the course of growth thereof, to the second layer wiring pattern 22 deposited on the catalyst pattern 22 through metallic bond.

According to the aforementioned procedures, production of the build-up substrate having two layers of wiring patterns 12 and 21 is completed. In the case where the build-up substrate 24 to be produced has three or more layers of wiring patterns 12, 21, the target build-up substrate 24 can be produced by repeating, after completing the electroless plating S10 for the second layer, the procedures of from the formation of a liquid repelling part S5 to the electroless plating S10 in a repetition time corresponding to the number of layers of the wiring patterns.

According to the embodiment of the method for producing a build-up substrate 24, the following advantages may be obtained.

(1) The liquid repelling agent 16 having liquid repellency to the ink for forming the insulating film 29 is ejected from the ink-jet head 14 onto the wiring pattern 12 to provide the liquid repelling part 17, and in this state, the ink for forming the insulating film is ejected from the ink-jet head 14 onto the portion except for the liquid repelling part 17 provided, thereby forming the insulating film 19. After eliminating the liquid repelling part 17, the contact part 23 electrically connecting the wiring patterns 12 and 21 formed through the insulating film 19 intervening therebetween, and the wiring pattern 21 are formed by the electroless plating. Accordingly, the insulating film 19 can be formed without photolithography, etching and perforation, and thus the build-up substrate 24 can be produced in a simplified process. Furthermore, the insulating film 19 can be formed by excluding accurately the position on the wiring pattern 12 where the contact part 23 is to be formed. Accordingly, the build-up structure can be formed in such a state that the contact part 23, which electrically connects the wiring patterns 12 and 21 disposed as being insulated from each other with the insulating film 19 intervening therebetween, is prevented from being fluctuated in cross sectional area and position thereof. Moreover, the wiring patterns 12 and 21 and the contact part 23 are formed without the use of an expensive electroconductive ink, which is different from a method of forming a wiring pattern and a contact part (conductor post) by ejecting and drying the electroconductive ink from an ink-jet head onto a substrate or an insulating film, and thus the production cost can be decreased.

(2) The process for forming the first layer wiring pattern 12 on a substrate contains the surface treatment S1, the formation of the catalyst pattern S2, the baking S3, and the electroless copper plating S4. The process for forming the second layer wiring pattern 21 and the contact part 23 electrically connecting the second layer wiring pattern 21 and the first layer wiring pattern 12 contains the formation of the liquid repelling part S5, the formation of the insulating film S6, the surface treatment of the insulating film S7, the formation of the catalyst pattern S8, the baking S9, and the electroless copper plating S10. The formation of the catalyst pattern S2 and S8, the formation of a liquid repelling part S5 and the formation of an insulating film S6 are performed by the liquid droplet ejecting method where liquid droplets are ejected from the ink-jet head 14. Accordingly, when the liquid droplet ejecting apparatus used is an apparatus equipped with plural liquid droplet ejecting heads or an apparatus equipped with a liquid droplet ejecting head having such a structure that plural kinds of liquids (inks) are fed separately to plural groups of nozzles of one head, the catalyst pattern, the liquid repelling part and the insulating film can be formed with one liquid droplet ejecting apparatus only by replacing the electronic file controlling the coating pattern (bitmap). Therefore, the production period can be shortened, and the production cost can be reduced. Furthermore, the build-up substrate 24 having three or more layers of wiring patterns 12, 21 can be produced in such a manner that after completing the electroless plating S10 for the second layer, the procedures of from the formation of a liquid repelling part S5 to the electroless plating S10 are performed in a repetition time corresponding to the number of layers of the wiring patterns.

(3) In the baking, the coupling agent having palladium (Pd) supported thereon for forming the catalyst patterns 15 and 22 is baked by heating the substrate 11 in a non-oxidizing atmosphere. Accordingly, as different from the case where the coupling agent is baked in the air, palladium is prevented from becoming partly palladium oxide (PdO), thereby enhancing the adhesion between the wiring patterns 12 and 21 and the portion where the wiring patterns are to be formed.

(4) In the surface treatment of the insulating film S7, the insulating film is irradiated with an ultraviolet ray by excimer laser. Accordingly, formation of the surface of the insulating film 19 with good affinity with the catalyst patterns 15 and 22 and the elimination of the liquid repelling part 17 can be performed easily by one operation.

(5) The electroless plating is performed by neutral electroless copper plating. Accordingly, as different from that case using an electroless copper plating bath being strongly alkaline with formaldehyde as a reducing agent, the adhesion between the coupling agent and the surface of the substrate 11 or the surface of the insulating film 19 can be prevented from being decreased. Furthermore, a less environmental load is imposed as compared to the case using a strongly alkaline plating bath, and the content of an alkali metal ion, which impairs reliability of semiconductors, is small, thereby facilitating the application of the method to a semiconductor device.

(6) The contact part 23 is formed by depositing directly on the surface of the wiring pattern without the catalyst pattern 22 intervening therebetween. Accordingly, the resistance at the junction between the wiring pattern 12 and the contact part 23 can be decreased as compared to the case where the contact part 23 is formed by combining ink droplets formed by drying an electroconductive ink.

The embodiment may contain, for example, the following modifications.

The embodiment may be applied not only to a multilayer wiring board having a build-up structure formed on one surface of a substrate, but also to a multilayer wiring board having build-up structures formed on both surfaces of a substrate. In the case where a multilayer wiring board having build-up structures formed on both surfaces of a substrate is produced, the production method therefor is not limited to such a method that the similar procedures as in the embodiment are performed on both surfaces of the substrate 11. For example, a substrate 11 having a hole 25 filled with an electroconductive material 26, such as a metal paste and an electroconductive ink, as shown in FIG. 4A may be used as the substrate 11, and the similar procedures as in the embodiment may be performed on both surfaces thereof, thereby producing a build-up substrate 24 shown in FIG. 4B.

In the case where the first layer of the multilayer wiring board is a solid pattern for a grounding layer, a substrate having copper plating on one surface or a substrate having copper plating on both surfaces may be used as the substrate, and procedures including the formation of the liquid repelling part S5 and later in the embodiment may be applied thereto. Furthermore, by using a copper-plated substrate, i.e., a substrate with the first layer wiring pattern, procedures including the formation of the liquid repelling part S5 and later in the embodiment may be applied thereto, and procedures of from the formation of the liquid repelling part S5 to the electroless plating S10 in the embodiment may be repeated in a repetition time corresponding to the number of layers of the wiring patterns, thereby producing the build-up substrate 24.

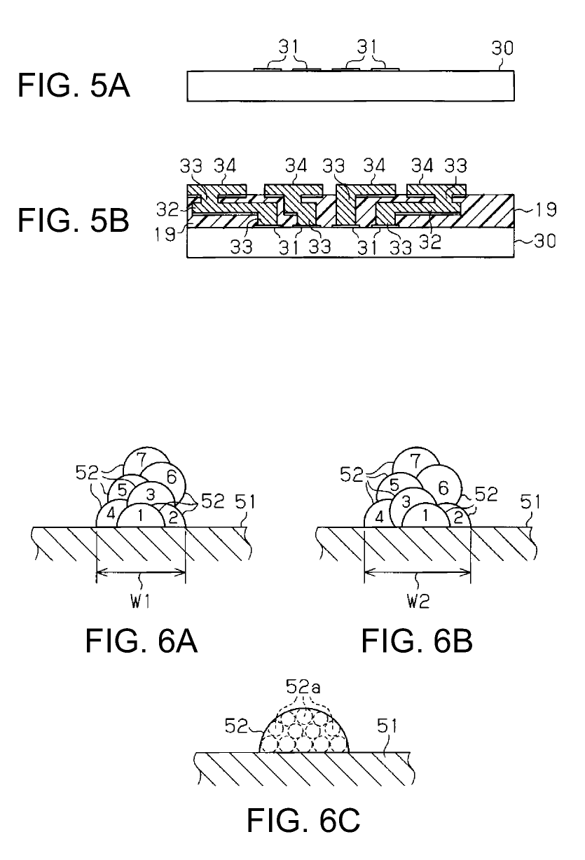

The build-up substrate is not limited to an ordinary multilayer wiring board, but the embodiment may be applied to an IC chip as a substrate, and a build-up structure may be formed directly on the IC chip. For example, as shown in FIG. 5A, an IC chip 30 having been processed until a pad 31 is formed may be used as a substrate, and procedures of from the formation of the liquid repelling part S5 to the electroless plating S10 in the embodiment may be repeated in a repetition time corresponding to the number of layers of the wiring patterns. The pad 31 may be a copper pad formed by a damascene process. Then, as shown in FIG. 5B, a wiring pattern 32 a contact part 33 and a pad 34 as a wiring pattern may be formed on the IC chip 30.

The surface treatment S1 may be performed on the portion of the substrate 11 where the wiring pattern 12 is to be formed, and for example, may be performed only on the portion where one of the wiring patterns 12 is to be formed instead of the surface treatment performed on the whole surface of the substrate 11.

The baking may be performed in the presence of air (for example, in the air) instead of the baking in a non-oxidizing atmosphere, but the baking is preferably performed in a non-oxidizing atmosphere.

The ultraviolet ray used in the ultraviolet ray irradiation in the surface treatment of the insulating film S7 is not limited to excimer light having a center wavelength of 172 nm, and krypton fluoride laser with a center wavelength of 248 nm or argon fluoride laser with a center wavelength of 193 nm may be used. The ultraviolet ray irradiation may be performed not only by excimer laser, but also by other methods than excimer laser.

The treatment for forming the surface of the insulating film 19 with good affinity with the catalyst liquid 13 may be performed by such a treatment that may not necessarily remove the liquid repelling part 17 favorably, and the removal of the liquid repelling part 17 may be performed separately.

The silane coupling agent used in the catalyst liquid 13 is not limited to one having an amino group, which is a functional group capable of supporting palladium as a plating catalyst, but one having an imidazole group may be used.

The formation of the catalyst pattern S2 and S8 is not limited to the method of ejecting the catalyst liquid 13 containing a solvent having dispersed therein the coupling agent having the plating catalyst supported thereon, onto the substrate 11 or the insulating film 19 to form the catalyst pattern 15, but for example, a solution of the coupling agent (silane coupling agent) capable of supporting a plating catalyst (palladium) may be ejected on the substrate 11 or the insulating film 19 to form a silane coupling agent layer, followed by performing a treatment for forming a Pd catalyst to form the catalyst pattern 15 or 22.

The catalytic metal in the plating catalyst is not limited to palladium, and other noble metals than palladium, such as gold, may be used.

The electroless copper plating is not limited to neutral electroless copper plating, and for example, electroless copper plating using a strongly alkaline plating bath using formaldehyde as a reducing agent may be employed.

The electroless plating is not limited to electroless copper plating, and for example, electroless gold plating and electroless silver plating may be employed. However, electroless gold plating and electroless silver plating may increase the cost.

The method of forming the contact part 23 is not limited to the method of depositing directly on the metal surfaces of the wiring patterns 12, 21 and 32 without the catalyst patterns 15 and 22, but may be deposited through the catalyst patterns 15 and 22.

The entire disclosure of Japanese Patent Application No. 2009-292729, filed Dec. 24, 2009 is expressly incorporated by reference herein.

What is claimed is:

1. A method for producing a build-up substrate containing two layers of wiring patterns that are separated from each other with an insulating film intervening therebetween and are electrically connected to each other at a contact part penetrating through the insulating film, the method comprising:
ejecting a liquid repelling agent having repellency to an ink for forming the insulating film from a liquid droplet ejecting head onto one of the wiring patterns, thereby forming a liquid repelling part;
then ejecting the ink for forming the insulating film from a liquid droplet ejecting head onto portions on the wiring pattern except for the liquid repelling part provided, thereby forming the insulating film;
then removing the liquid repelling part; and
then forming the contact part and the other of the wiring patterns by electroless plating.

2. The method for producing a build-up substrate according to claim 1, wherein
the one of the wiring patterns is formed by a method comprising:
surface-treating a substrate on at least a portion where the wiring pattern is to be formed;
forming a catalyst pattern by ejecting a catalyst liquid from a liquid droplet ejecting head onto the substrate, on the portion where the wiring pattern is to be formed;
baking the catalyst pattern; and
performing electroless plating on the baked catalyst pattern to form the one of the wiring patterns, and
the contact part and the other of the wiring patterns are formed by a method comprising:
forming a liquid repelling part by ejecting a liquid repelling agent having repellency to an ink for forming the insulating film from a liquid droplet ejecting head onto the one of the wiring patterns formed by the electroless plating, on a portion where the contact part is to be formed;
forming an insulating film by ejecting an ink for forming the insulating film from a liquid droplet ejecting head onto the substrate except for the liquid repelling part provided, and then baking the ink;
surface-treating the insulating film by performing simultaneously a surface treatment of the insulating film and removal of the liquid repelling part, under a condition where the liquid repelling part is removed;
forming a catalyst pattern by ejecting a catalyst liquid from a liquid droplet ejecting head onto the insulating film surface-treated, on the portion where the wiring pattern is to be formed;
baking the catalyst pattern; and
performing electroless plating on the baked catalyst pattern to form the other of the wiring patterns and the contact part.

3. The method for producing a build-up substrate according to claim 2, wherein the catalyst pattern is formed with a coupling agent having palladium supported thereon, and the catalyst pattern is baked in a non-oxidizing atmosphere.

4. The method for producing a build-up substrate according to claim 2, wherein the insulating film is surface-treated by irradiating with an ultraviolet ray by excimer laser.

5. The method for producing a build-up substrate according to claim 3, wherein the electroless plating is neutral electroless copper plating.

6. The method for producing a build-up substrate according to claim 2, wherein the contact part is formed by depositing directly on a surface of the wiring pattern without the catalyst pattern intervening therebetween.
